(19) United States
(12) Patent Application Publication
(10) Pub. No.: US 2025/0287271 A1
(43) Pub. Date: Sep. 11, 2025

(54) VOICE CALL CONTINUITY IMPROVEMENTS FROM WLAN TO WWAN

(71) Applicant: QUALCOMM Incorporated, San Diego, CA (US)

(72) Inventors: Akash SRIVASTAVA, Hyderabad (IN); Siva Krishna ALLU, Hyderabad (IN); Santhana PALANISAMY, Hyderabad (IN); Srinivasa Ragimakalahally KONAPPA, Bangalore (IN); Upendra Ram PRATURI, Hyderabad (IN); Jayaraj THALAPATHI, Coimbatore (IN); Varun BHATIA, Ghaziabad (IN)

(21) Appl. No.: 18/596,337

(22) Filed: Mar. 5, 2024

(51) Int. Cl. H04W 36/00; H04W 36/14; H04W 36/30; H04W 36/36; H04W 88/06

(52) U.S. Cl. CPC H04W 36/00226; H04W 36/1446; H04W 36/304; H04W 36/362; H04W 88/06

(57) ABSTRACT

Certain aspects of the present disclosure provide techniques for improving voice call continuity from a wireless local area network (WLAN) to a wireless wide area network (WWAN). An example method performed by a user equipment (UE) includes performing, while a session is active on a first radio access technology (RAT) network, reselection to a second RAT network from a third RAT network, performing a handover to the second RAT network, after detecting a condition impacting the session on the first RAT network, and resuming the session on the second RAT network.

### BACKGROUND

### Field of the Disclosure

Aspects of the present disclosure relate to wireless communications, and more particularly, to techniques for improving voice call continuity from a wireless local area network (WLAN) to a wireless wide area network (WWAN).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes performing, while a session is active on a first radio access technology (RAT) network, reselection to a second RAT network from a third RAT network; performing a handover to the second RAT network, after detecting a condition impacting the session on the first RAT network; and resuming the session on the second RAT network.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 is a call flow diagram including operations that illustrate a call muting issue.

FIG. 6 is a call flow diagram including operations that illustrate a call dropping issue.

FIG. 7 depicts a process flow for communications in a network for alleviating the call muting issue.

FIG. 8 depicts a process flow for communications in a network or alleviating the call dropping issue.

FIG. 9 depicts a method for wireless communications.

FIG. 10 depicts aspects of an example communications device.

### DETAILED DESCRIPTION

Aspects of the present disclosure provide apparatuses, methods, processing systems, and computer-readable mediums for improving voice call continuity from a wireless local area network (WLAN) to a wireless wide area network (WWAN).

For example, in some cases, a user equipment (UE) may be capable of performing a voice call over a WLAN radio access technology (RAT) network, such as WiFi RAT network. When doing so, however, there may be some scenarios in which a quality or strength of a connection to the WLAN deteriorates or drops below a threshold, which may significantly impact a quality of the voice call. When the quality or strength of the connection drops below the threshold, the UE may be configured to perform a handover from the WLAN RAT network to a WWAN RAT network, such as a long term evolution (LTE) RAT network, to reestablish and continue the voice call. Generally, this process may be known as evolved packet system fall back (EPSFB). In other words, when the voice call on the WLAN RAT network is interrupted (e.g., due to the quality or signal strength of the connection deteriorating below the threshold), EPSFB involves the UE falling back to the LTE RAT network to continue the voice call.

However, in some cases, the LTE RAT network may have a lower priority relative to another WWAN RAT network, such as a fifth generation new radio (5G NR) RAT network. As a result of the 5G NR RAT network having a relatively higher priority, the UE may be required to first perform a handover from the WLAN RAT network (e.g., WiFi RAT network) to the 5G NR RAT network before being redirected by the 5G NR RAT network to the LTE RAT network. In other words, the UE may first have to perform a handover to the 5G NR RAT network, receive a redirection command from the 5G RAT network, and then perform another handover to the LTE RAT network.

Having to perform a handover to the 5G NR RAT network, receive the redirection command, and then perform a second handover to the LTE RAT network consumes a significant amount of time. Moreover, during the period of time when these handovers are occurring, the voice call will remain muted (e.g., no voice data is able to be communicated, which leads to poor user experience at the UE.

Additionally, in some cases, there may be scenarios in which the handover to the 5G NR RAT network is rejected and the UE is not redirected to the LTE RAT network. When the handover to the 5G NR RAT network is rejected, the UE may be forced to stay on the WLAN RAT network until the connection deteriorates to a certain level that the voice call drops, again leading to poor user experience at the UE.

Accordingly aspects of the present disclosure provide techniques to help alleviate the call muting and call dropping issues that may arise when performing a voice call over a WLAN RAT network. For example, in some cases, to help alleviate the call muting issue, these techniques may involve the UE performing a reselection procedure during the voice call to reselect the LTE RAT network prior to a WLAN connection deteriorating below a threshold and irrespective of a relative priority assigned to the LTE RAT network. This may allow the UE to skip performing the handover to the 5G NR RAT network when the connection to the WLAN network deteriorates below the threshold and instead directly perform the handover to the LTE RAT network, thereby reducing the amount of time it takes to handover to the LTE RAT network and to reestablish the voice call.

Additionally, to help alleviate the call dropping issues, the techniques provided herein may involve the UE de-prioritizing a 5G RAT network and attempting a handover to an LTE network entity when the UE receives a handover reject message from a 5G network entity on the 5G RAT network. This may avoid the scenario in which the UE is effectively stuck on the WLAN RAT network and unable to handover to the LTE network entity due to the 5G RAT network having priority over the LTE RAT network. For example, by de-prioritizing a 5G RAT network, the UE may then be free to attempt a handover to an LTE network entity to reestablish and continue the voice call.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

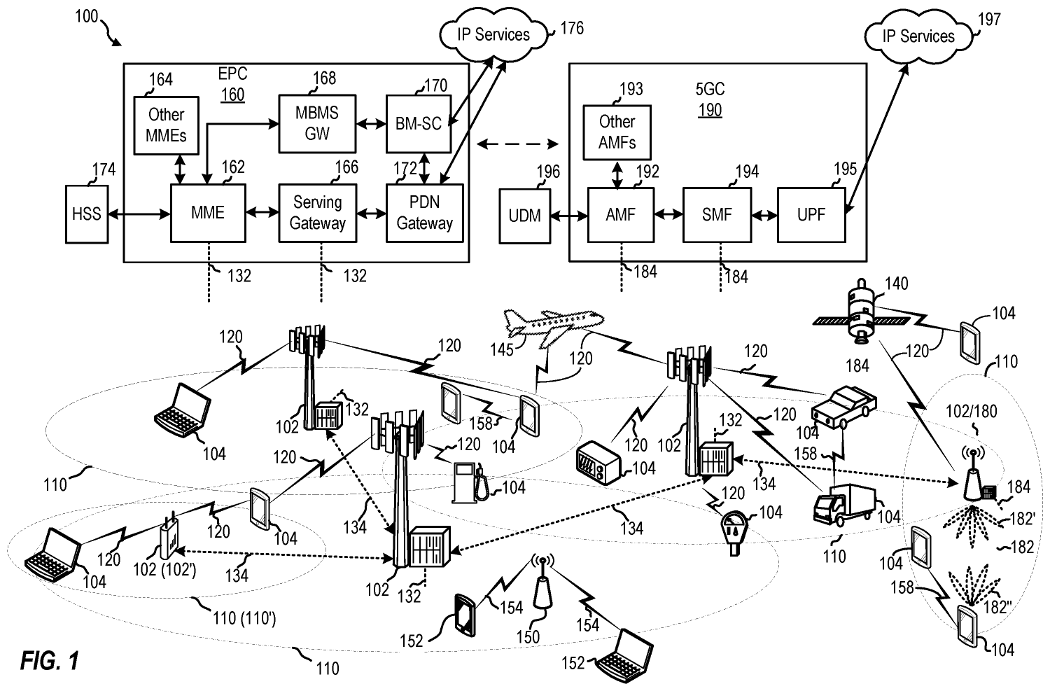

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

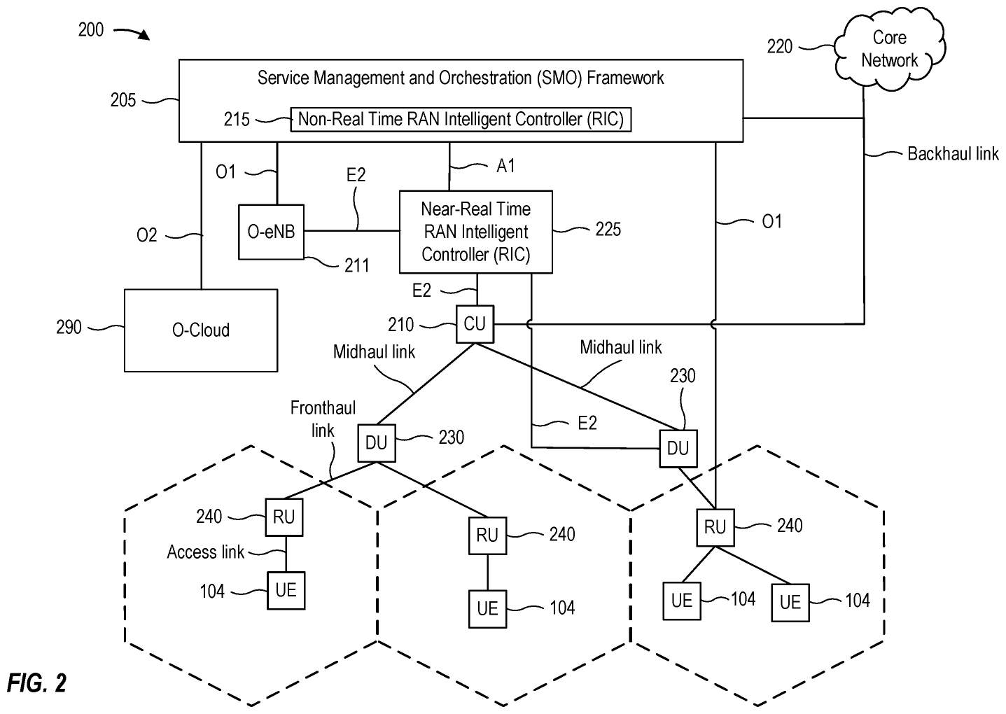

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

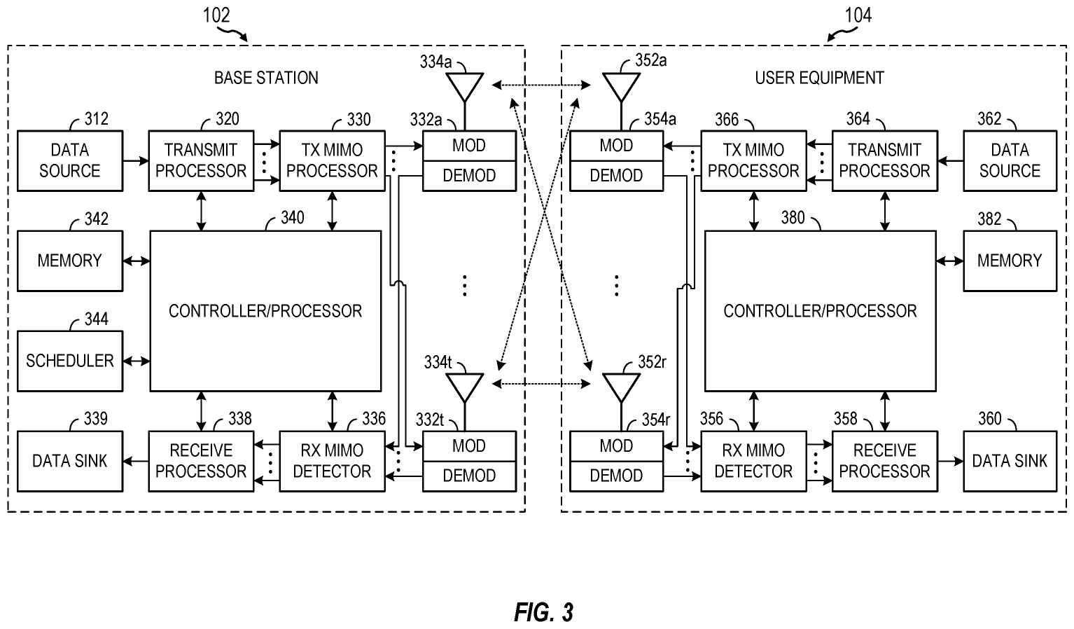

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

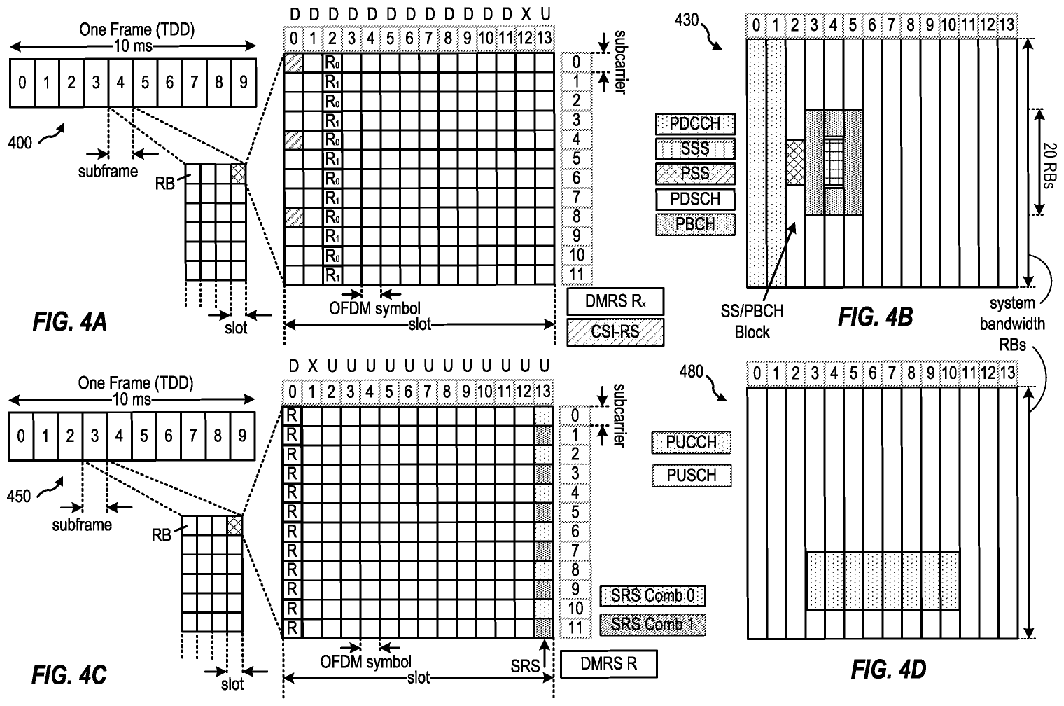

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Improvements for Voice Call Continuity from WLAN to WWAN

Many wireless carriers are wireless local area network (WLAN)-preferred (e.g., WiFi-preferred) carriers as compared to wireless wide area network (WWAN)-preferred (e.g., cellular-preferred). In other words, these carriers prefer that voice calls be made over WLAN, as compared to over cellular or WWAN services. Under WLAN coverage, user equipments (UEs) would be required to camp on a WLAN access point (AP) for making and receiving calls. With fifth generation new radio (5G NR) standalone (SA) becoming increasingly commercialized by major cellular operators, internet protocol multimedia subsystem (IMS) calls are becoming possible over 5G NR, long term evolution (LTE), and WLAN (e.g., WiFi).

In some cases, certain original equipment manufacturers (OEMs) have configured their devices (e.g., UEs) with a preference for LTE evolved packet system fallback (EPSFB) for voice calls rather than voice over new radio (VoNR) due to equality concerns and device capability. In other words, when making voice calls, these devices (e.g., UEs) may be configured to fall back from a 5G NR radio access technology (RAT) network to an LTE RAT network due to quality concerns and device compatibility issues. In some cases, however, the EPSFB may cause certain issues with voice calls over a WLAN RAT network, such as call muting and call dropping.

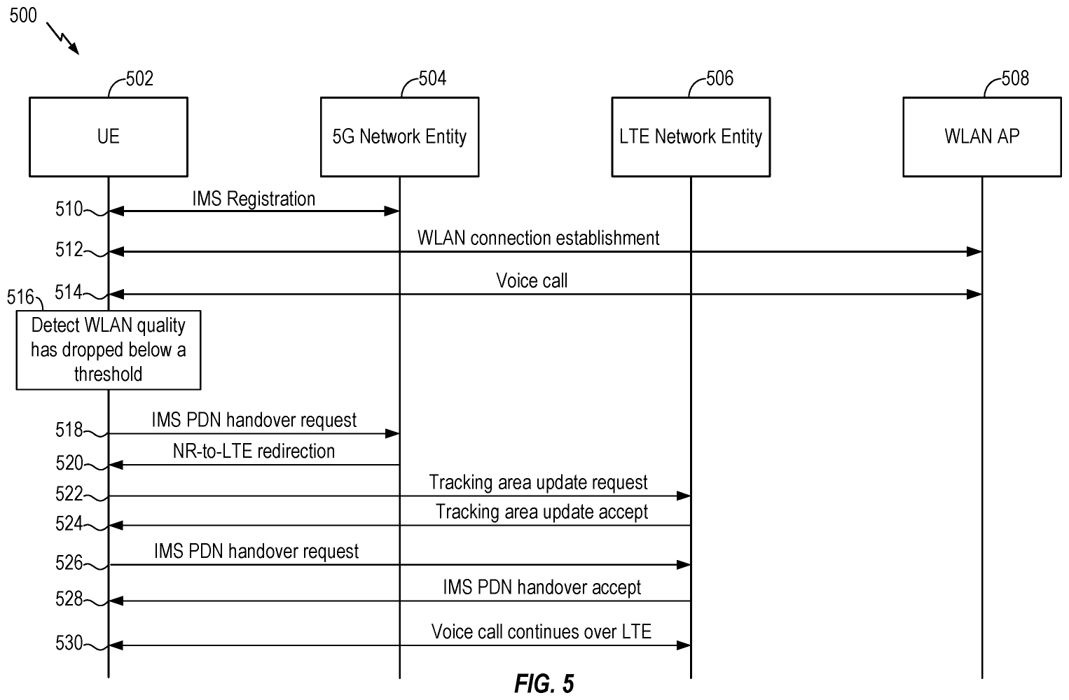

FIG. 5 is a call flow diagram including operations 500 that illustrate the call muting issue that may arise when an EPSFB-based UE performs a voice call over a WLAN RAN, such as WiFi. For example, as shown, operations 500 illustrated in FIG. 5 involve a UE 502, a 5G network entity 504, an LTE network entity 506, and a WLAN AP 508. In some cases, the UE 502 may be capable of performing WLAN-based voice calls and EPSFB-based voice calls. In other words, the UE 502 may perform voice calls over a WLAN RAT network (e.g., a WiFi network) or, when using cellular- or WWAN-based service, may be required to fall back to an LTE RAT network to perform a voice call.

As illustrated, operations 500 begin at 510 with the UE 502 performing IMS registration with the 5G network entity 504 for data services using a 5G RAT network.

Thereafter, at 512, the UE 502 may establish a connection with the WLAN AP 508 using the WLAN RAT network.

Thereafter, as shown at 514, the UE 502 initiates and performs a voice call via the WLAN AP 508.

At 516, during the voice call, the UE 502 detects that a quality or strength of the connection with the WLAN AP 508 (e.g., a signal strength or quality of the WLAN RAT network) has dropped below a particular threshold, significantly impacting a quality of the voice call.

In response to detecting that the quality or strength of the connection with the WLAN AP 508 has dropped below the particular threshold, at 518, the UE 502 transmits an IMS PDN handover request to the 5G network entity 504, requesting that the UE 502 be handed over to the 5G network entity 504 to continue the voice call. It should be appreciated that, even though the UE 502 is an EPSFB-based UE, the UE 502 transmits the IMS PDN handover request to the 5G network entity 504 due to the 5G RAT network having priority over the LTE RAT network.

Thereafter, as shown at 520, because the UE 502 is an EPSFB-based UE, the 5G network entity 504 redirects the UE 502 to the LTE network entity 506 based on the IMS PDN handover request.

As shown at 522, the UE 502 transmits a tracking area update (TAU) request message to the LTE network entity 506. The UE 502 then receives a TAU accept message from the LTE network entity 506 at 524.

Thereafter, as shown at 526, the UE 502 transmits another IMS PDN handover request to the LTE network entity 506, requesting a handover from the WLAN AP 508 to LTE network entity 506 in order to continue the voice call that was initiated with the WLAN AP 508.

At 528, the UE 502 then receives a PDN handover accept message from the LTE network entity 506 based on the IMS PDN handover request.

At 530, the UE 502 may continue the voice call over the LTE RAT network after the handover from WIFI to LTE is complete.

As can be seen in FIG. 5, when the quality or strength of the WLAN connection deteriorates below a threshold during a voice call being performed by an EPSFB-based UE, the process for reestablishing or continuing that voice call involves multiple handovers, which causes the voice call to be muted (e.g., no voice data is able to be communicated) for a significant amount of time. This muting issue, in turn, leads to poor user experience at the UE.

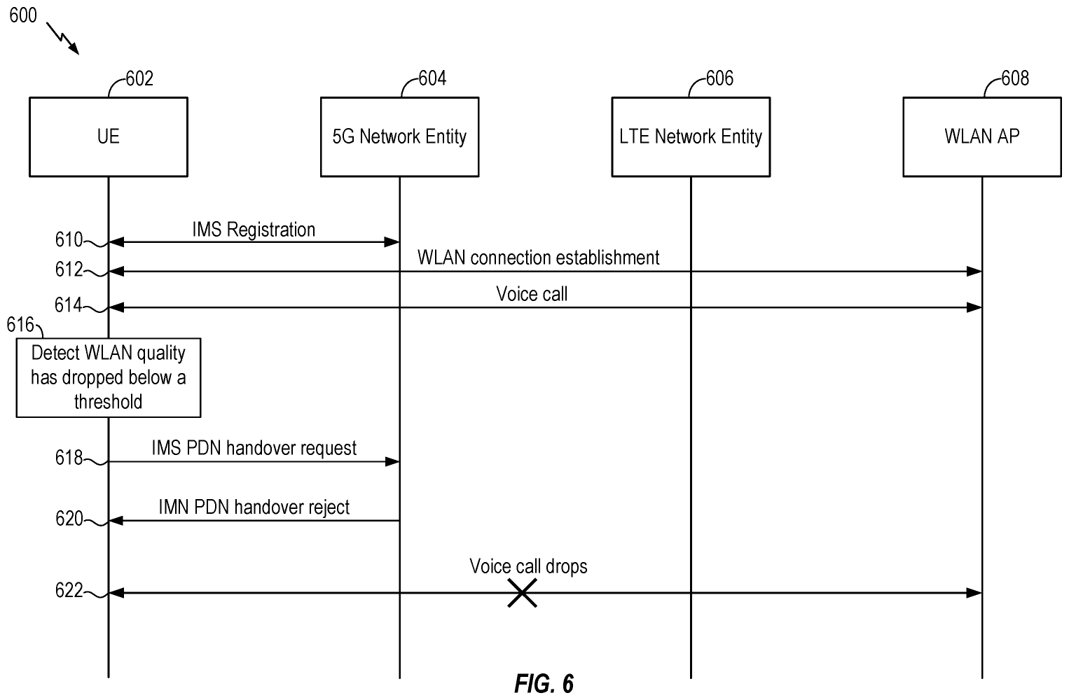

As noted above, EPSFB may also cause call dropping issues with VoWIFI calls. FIG. 6 is a call flow diagram including operations 600 that illustrate the call muting issue that may arise when an EPSFB-based UE performs a voice call over a WLAN RAT network, such as WiFi. For example, as shown, operations 600 illustrated in FIG. 6 involve a UE 602, a 5G network entity 604, an LTE network entity 606, and a WLAN AP 608. In some cases, the UE 602 may be capable of performing WLAN-based voice calls and EPSFB-based voice calls. In other words, the UE 602 may perform voice calls over a WLAN RAT network (e.g., WiFi) or, when using cellular- or WWAN-based service, may be required to fall back to an LTE RAT network to perform a voice call.

As illustrated, operations 600 begin at 610 with the UE 602 performing IMS registration with the 5G network entity 604 for data services using a 5G RAT network.

Thereafter, at 612, the UE 602 may establish a connection with the WLAN AP 608 using the WLAN RAT network.

Thereafter, as shown at 614, the UE 602 initiates and performs a voice call via the WLAN AP 608.

At 616, during the voice call, the UE 602 detects that a quality or strength of the connection with the WLAN AP 608 (e.g., a signal strength or quality of the WLAN RAT network) has dropped below a particular threshold, significantly impacting a quality of the voice call.

In response to detecting that the quality or strength of the connection with the WLAN AP 608 has dropped below the particular threshold, at 618, the UE 602 transmits an IMS PDN handover request to the 5G network entity 604, requesting that the UE 602 be handed over to the 5G network entity 604 to continue the voice call. As noted above, it should be appreciated that, even though the UE 602 is an EPSFB-based UE, the UE 602 transmits the IMS PDN handover request to the 5G network entity 604 due to the 5G RAT network having priority over the LTE RAT network.

In some cases, however, as shown at 620, due to certain issues at the 5G network entity 604, instead of redirecting the UE 602 over to the LTE network entity 606, the 5G network entity 604 instead transmits an IMS PDN handover reject message to the UE 502, indicating that the handover to the 5G network entity 604 has failed. In some cases, receiving the IMS PDN handover reject message from the 5G network entity 604 may lead to the UE 602 remaining “stuck” on the WLAN RAT network since the UE 602 will continue to prioritize the 5G RAT network over the LTE RAT network, leading to the UE 602 continually trying to handover to the 5G network entity 604 and being rejected. This process may continue indefinitely until the connection established with the WLAN AP 608 fails and the voice call is dropped. For example, as shown at 622, as a result of the handover failing and not being redirected to the LTE network entity 606, the voice call may drop or fail, leading to poor user experience.

Accordingly aspects of the present disclosure provide techniques to help alleviate the issues of call muting and call dropping that may arise when an EPSFB-based UE performs a voice call over a WLAN RAT network. For example, in some cases, to help alleviate the call muting issue described above with respect to FIG. 5, these techniques may involve the UE performing a reselection procedure during the voice call to reselect the LTE RAT network prior to a WLAN connection deteriorating below a threshold. In some cases, the UE may perform the reselection procedure to reselect to the LTE RAT network irrespective of a relative priority assigned to the LTE RAT network. By performing the reselection procedure to reselect to the LTE RAT network prior to the WLAN connection deteriorating below the threshold, the UE may avoid having to perform the handover from a WLAN AP to a 5G network entity. In other words, by performing the reselection procedure to reselect to the LTE RAT network prior to the WLAN connection deteriorating below the threshold, the UE can avoid performing at least operations 518, 520, 522, and 524 to reestablish the voice call when the WLAN connection deteriorates below the threshold. This may reduce the amount of time it takes to reestablish the voice call when the WLAN connection deteriorates below the threshold, thereby avoiding the negative impacts to user experience described above.

In other cases, to help alleviate the call dropping issues describe above with respect to FIG. 6, the techniques provided herein may involve the UE de-prioritizing a 5G RAT network and attempting a handover to an LTE network entity when the UE receives a handover reject message from a 5G network entity on the 5G RAT network. This may avoid the scenario in which the UE is effectively stuck on the WLAN RAT network and unable to handover to the LTE network entity due to the 5G RAT network having priority over the LTE RAT network, as described above. For example, as noted, by de-prioritizing a 5G RAT network, the UE may then be free to attempt a handover to an LTE network entity to reestablish and continue the voice call.

### Example Operations of Entities in a Communications Network

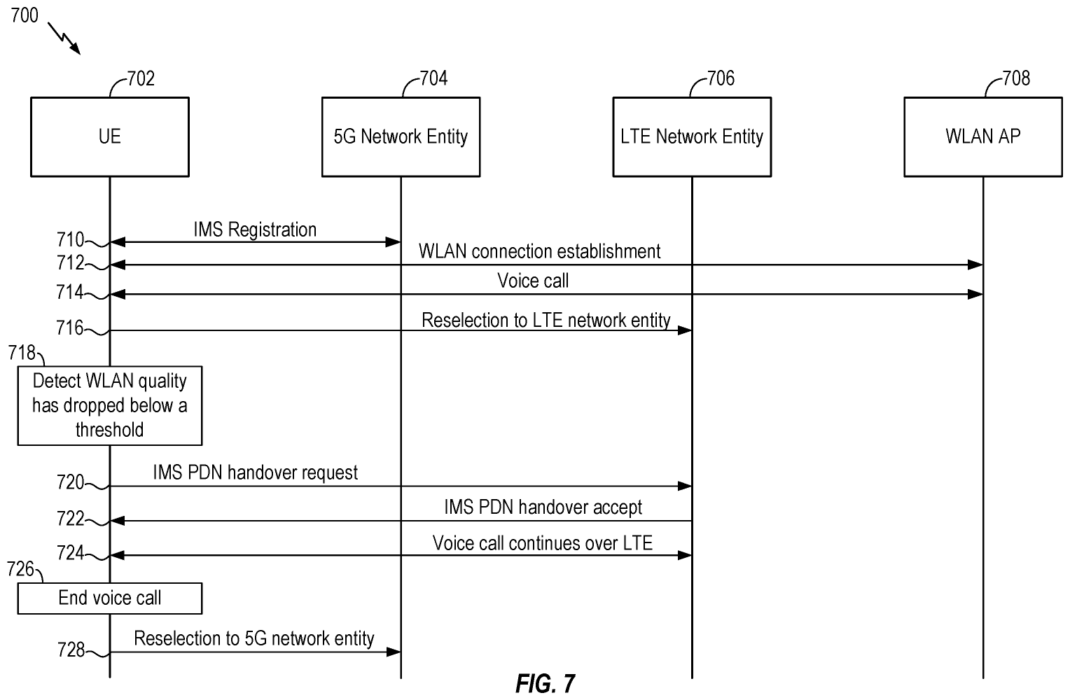

FIG. 7 depicts a process flow including operations 700 for communications in a network between a UE 702, a 5G network entity 704, an LTE network entity 706, and a WLAN AP 708. In some aspects, the 5G network entity 704 and the LTE network entity 706 may be examples of the BS 102 depicted and described with respect to FIGS. 1 and 3 or a disaggregated base station depicted and described with respect to FIG. 2. Similarly, the UE 702 may be an example of UE 104 depicted and described with respect to FIGS. 1 and 3. In some cases, the WLAN AP 708 may be an example of a WiFi access point. Additionally, in some cases, the UE 702 may be capable of performing WLAN-based voice calls or sessions and EPSFB-based voice calls or sessions. In other words, the UE 702 may perform voice calls over a WLAN RAT network (e.g., WiFi) or, when using cellular- or WWAN-based service, may be required to fall back to an LTE RAT network to perform a voice call.

As illustrated, operations 700 begin at 710 with the UE 702 performing IMS registration with the 5G network entity 704 for data services using a 5G RAT network.

Thereafter, at 712, the UE 702 may establish a connection with the WLAN AP 708 using the WLAN RAT network.

Thereafter, as shown at 714, the UE 702 initiates and performs a voice call via the WLAN AP 708.

Thereafter, as shown at 716, prior to a quality or strength of the connection with the WLAN AP 708 (e.g., a signal strength or quality of the WLAN RAT network) has dropping below a particular threshold, the UE 702 may perform reselection to the LTE network entity 706. For example, the UE 702 may reselect to the LTE network entity 706 autonomously (e.g., without involvement of the 5G RAT network) and may, thereafter, initiate a TAU or registration procedure to inform the LTE RAT network that the UE 702 is camped on the LTE network entity 706.

Thereafter, at 718, during the voice call, the UE 702 may detect that the quality or the strength of the connection with the WLAN AP 708 (e.g., a signal strength or quality of the WLAN RAT network) has dropped below the particular threshold, significantly impacting a quality of the voice call. For example, in some cases, the UE 702 may detect that a received signal strength indicator (RSSI) associated with the connection with the WLAN AP 708 has fallen below an RSSI threshold.

In such cases, at 720, rather than first sending a handover request to the 5G network entity 704, the UE 702 may instead send an IMS PDN handover request (e.g., an EPSFB-based handover) to the LTE network entity 706 based the reselection that the UE 702 performed at 716. Accordingly, at 722, based on the IMS PDN handover request, the UE 702 may receive an IMS PDN handover accept message from the LTE network entity 706, allowing the UE 702 to be handed over to the LTE network entity 706.

Thereafter, as shown at 724, the voice call may be reestablished and may continue via the LTE network entity 706 using the LTE RAT network. As noted above, by performing reselection to the LTE network entity 706 prior to the quality or strength of the connection with the WLAN AP 708 deteriorating below the threshold, the UE 702 may be able to more quickly reestablish the voice call using the LTE RAT network, thereby reducing negative effects to user experience at the UE 702.

Thereafter, as shown at 726, the UE 702 may end the voice call.

Thereafter, as shown at 728, once the voice call has ended, the UE 702 may perform reselection back to the 5G network entity 704.

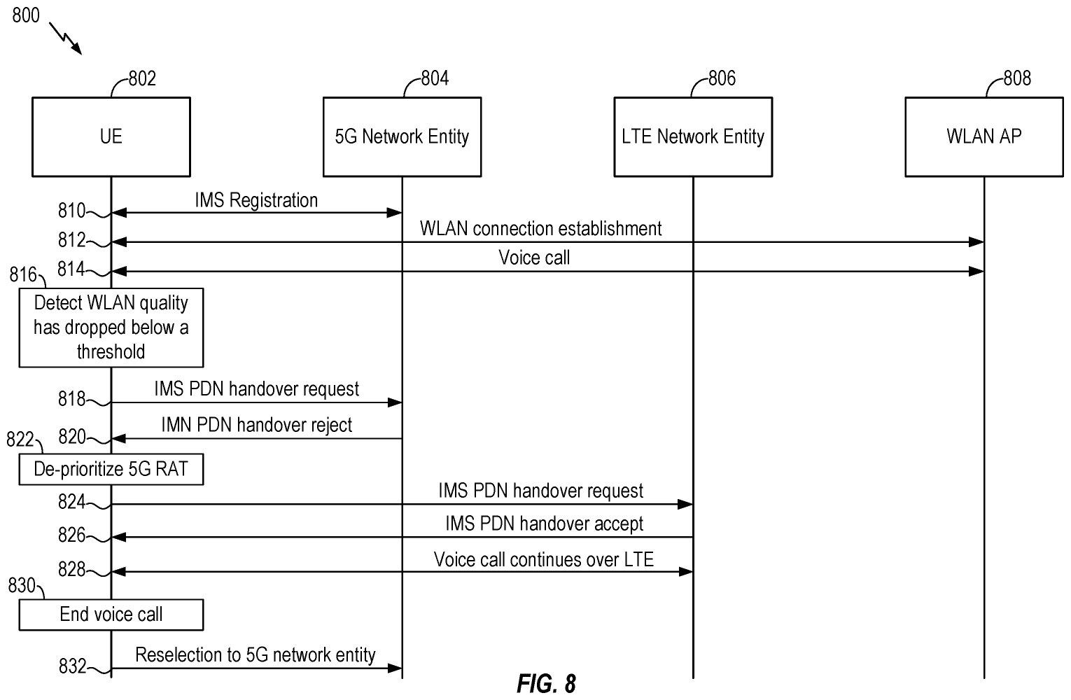

FIG. 8 depicts a process flow including operations 800 for communications in a network between a UE 802, a 5G network entity 804, an LTE network entity 806, and a WLAN AP 808. In some aspects, the 5G network entity 804 and the LTE network entity 806 may be examples of the BS 102 depicted and described with respect to FIGS. 1 and 3 or a disaggregated base station depicted and described with respect to FIG. 2. Similarly, the UE 802 may be an example of UE 104 depicted and described with respect to FIGS. 1 and 3. In some cases, the WLAN AP 808 may be an example of a WiFi access point. Additionally, in some cases, the UE 802 may be capable of performing WLAN-based voice calls or sessions and EPS FB-based voice calls or sessions. In other words, the UE 602 may perform voice calls over a WLAN RAT network (e.g., WiFi) or, when using cellular- or WWAN-based service, may be required to fall back to an LTE RAT network to perform a voice call.

As illustrated, operations 800 begin at 810 with the UE 802 performing IMS registration with the 5G network entity 804 for data services using a 5G RAT network.

Thereafter, at 812, the UE 802 may establish a connection with the WLAN AP 808 using the WLAN RAT network.

Thereafter, as shown at 814, the UE 802 initiates and performs a voice call via the WLAN AP 808.

At 816, during the voice call, the UE 802 detects that a quality or strength of the connection with the WLAN AP 808 (e.g., a signal strength or quality of the WLAN RAT network) has dropped below a particular threshold, significantly impacting a quality of the voice call. For example, in some cases, the UE 802 may detect that an RSSI associated with the connection with the WLAN AP 808 has fallen below an RSSI threshold.

In response to detecting that the quality or strength of the connection with the WLAN AP 808 has dropped below the particular threshold, at 818, the UE 802 transmits an IMS PDN handover request to the 5G network entity 804, requesting that the UE 802 be handed over to the 5G network entity 804 to continue the voice call. As noted above, it should be appreciated that, even though the UE 802 is an EPSFB-based UE, the UE 802 transmits the IMS PDN handover request to the 5G network entity 804 due to the 5G RAT network having priority over the LTE RAT network.

In some cases, however, as shown at 820, due to certain issues at the 5G network entity 804, instead of redirecting the UE 802 over to the LTE network entity 806, the 5G network entity 804 instead transmits an IMS PDN handover reject message to the UE 502, indicating that the handover to the 5G network entity 804 has failed.

In order to avoid a scenario in which the UE 802 is “stuck” on the WLAN RAT network due to the 5G RAT network having a higher priority than the LTE RAT network and the handover to the 5G network entity 804 failing (e.g., as described above with respect to FIG. 6), the UE 802 may de-prioritize the 5G RAT network at 822 and instead transmit a IMS PDN handover request to the LTE network entity 806 at 824. As shown at 826, the UE 802 receives an IMS PDN handover accept message from the LTE network entity 806, allowing the UE 802 to be handed over to the LTE network entity 806.

Thereafter, as shown at 828, the voice call may be reestablished and may continue via the LTE network entity 806 using the LTE RAT network. As noted above, by de-prioritizing the 5G RAT network and instead performing the handover to the LTE network entity 806 (e.g., even though the 5G RAT network has a higher relative priority than the LTE RAT network), the UE 802 is able to avoid scenarios in which the voice call drops due to the UE 802 being “stuck” on the WLAN RAT network, thereby reducing negative effects to user experience at the UE 802.

Thereafter, as shown at 830, the UE 802 may end the voice call.

Thereafter, as shown at 832, once the voice call has ended, the UE 802 may perform reselection back to the 5G network entity 804.

It should be appreciated that the operations illustrated in FIGS. 7 and 8 may be applicable to other types of network entities associated with other types of RAT networks, such as a network entities associated with a sixth generation (6G) RAT network, network entities associated with a third generation (3G) RAT network, and the like. As an example, in some cases, the LTE network entity 706 may instead by a network entity associated with a 5G RAT network and the 5G network entity 704 may be a network entity associated with a 6G RAT network.

### Example Operations of a User Equipment

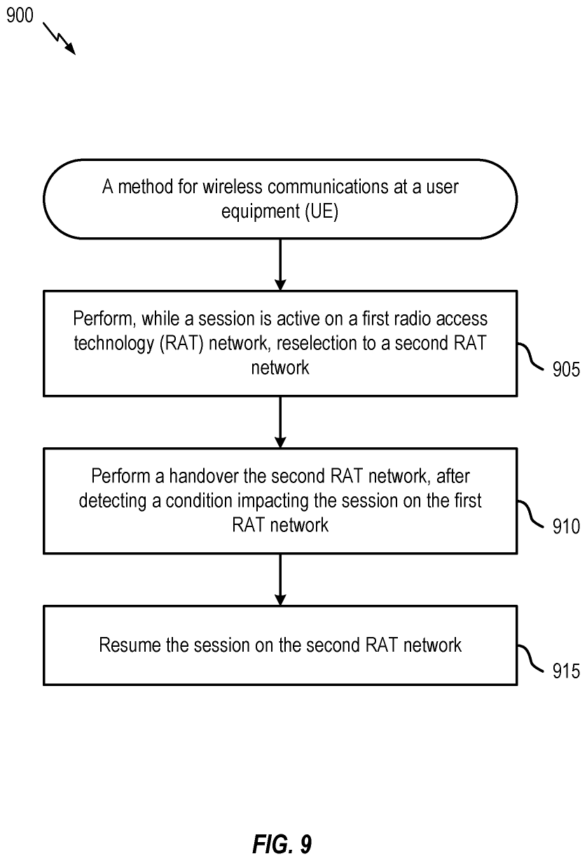

FIG. 9 shows an example of a method 900 of wireless communications at a user equipment (UE), such as a UE 104 of FIGS. 1 and 3.

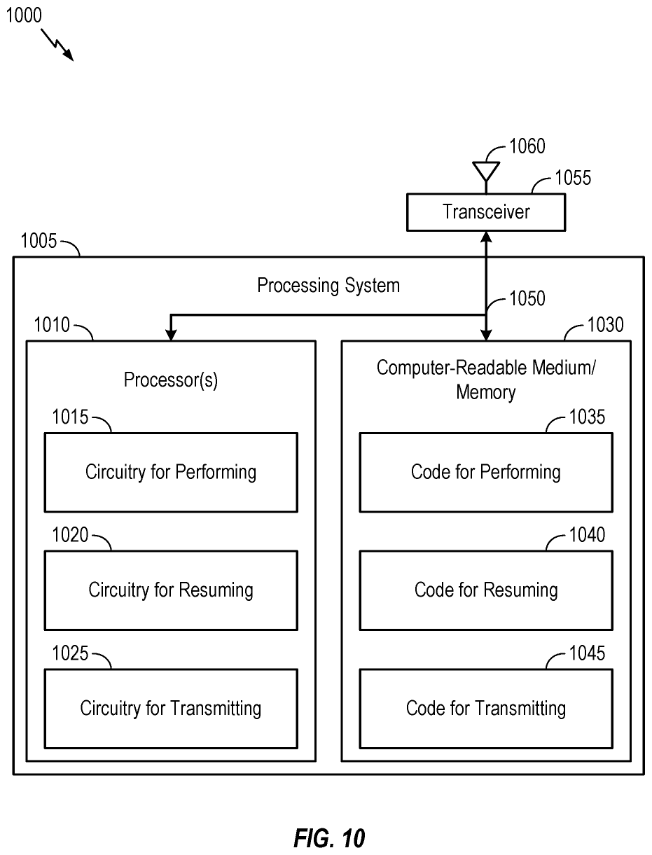

Method 900 begins at step 905 with performing, while a session is active on a first radio access technology (RAT) network, reselection to a second RAT network from a third RAT network. In some cases, the operations of this step refer to, or may be performed by, circuitry for performing and/or code for performing as described with reference to FIG. 10.

In some aspects, the session may comprise a voice call and the UE is capable of supporting evolved packet system (EPS) fallback for the voice call. In some aspects, the first RAT network comprises a WLAN, such as a WiFi network or another type of WLAN. In some aspects, the second and third RAT networks comprise wireless wide area networks (WWANs). For example, in some aspects, the second RAT network comprises an LTE network and third RAT network comprises a 5G NR network.

Method 900 then proceeds to step 910 with performing a handover to the second RAT network, after detecting a condition impacting the session on the first RAT network. In some cases, the operations of this step refer to, or may be performed by, circuitry for performing and/or code for performing as described with reference to FIG. 10.

Method 900 then proceeds to step 915 with resuming the session on the second RAT network. For example, in some aspects resuming the session on the second RAT network may include resuming the voice call on the second RAT network. In some cases, the operations of this step refer to, or may be performed by, circuitry for resuming and/or code for resuming as described with reference to FIG. 10.

In some aspects, the condition involves signal quality in the first RAT network. For example, in some aspects, the condition may include the signal quality in the first RAT network falling below a threshold.

In some aspects, performing the handover comprises transmitting a packet data network (PDN) handover request to the second RAT network. For example, in some aspects, transmitting the handover request to the second RAT network may include transmitting the handover request to a network entity of the second RAT network.

In some aspects, the session is resumed on the second RAT network after receiving an acceptance of the PDN handover request.

In some aspects, the method 900 further includes performing reselection to a third RAT network after an end of the session on the second RAT network. In some cases, the operations of this step refer to, or may be performed by, circuitry for performing and/or code for performing as described with reference to FIG. 10.

In some aspects, the UE is camped on the third RAT network when it performs the reselection to the second RAT network.

In some aspects, the UE performs the reselection to the second RAT network irrespective of a relative priority assigned to the third RAT and second RAT.

In one aspect, method 900, or any aspect related to it, may be performed by an apparatus, such as communications device 1000 of FIG. 10, which includes various components operable, configured, or adapted to perform the method 900. Communications device 1000 is described below in further detail.

Note that FIG. 9 is just one example of a method, and other methods including fewer, additional, or alternative steps are possible consistent with this disclosure.

### Example Communications Devices

FIG. 10 depicts aspects of an example communications device 1000. In some aspects, communications device 1000 is a user equipment, such as UE 104 described above with respect to FIGS. 1 and 3.

The communications device 1000 includes a processing system 1005 coupled to the transceiver 1055 (e.g., a transmitter and/or a receiver). The transceiver 1055 is configured to transmit and receive signals for the communications device 1000 via the antenna 1060, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. The one or more processors 1010 are coupled to a computer-readable medium/memory 1030 via a bus 1050. In certain aspects, the computer-readable medium/memory 1030 is configured to store instructions (e.g., computer-executable code) that when executed by the one or more processors 1010, cause the one or more processors 1010 to perform the method 900 described with respect to FIG. 9, or any aspect related to it. Note that reference to a processor performing a function of communications device 1000 may include one or more processors 1010 performing that function of communications device 1000.

In the depicted example, computer-readable medium/memory 1030 stores code (e.g., executable instructions), such as code for performing 1035, code for resuming 1040, and code for transmitting 1045. Processing of the code for performing 1035, code for resuming 1040, and code for transmitting 1045 may cause the communications device 1000 to perform the method 900 described with respect to FIG. 9, or any aspect related to it.

The one or more processors 1010 include circuitry configured to implement (e.g., execute) the code stored in the computer-readable medium/memory 1030, including circuitry such as circuitry for performing 1015, circuitry for resuming 1020, and circuitry for transmitting 1025. Processing with circuitry for performing 1015, circuitry for resuming 1020, and circuitry for transmitting 1025 may cause the communications device 1000 to perform the method 900 described with respect to FIG. 9, or any aspect related to it.

Various components of the communications device 1000 may provide means for performing the method 900 described with respect to FIG. 9, or any aspect related to it. For example, means for transmitting, sending or outputting for transmission may include transceivers 354 and/or antenna(s) 352 of the UE 104 illustrated in FIG. 3 and/or the transceiver 1055 and the antenna 1060 of the communications device 1000 in FIG. 10. Means for receiving or obtaining may include transceivers 354 and/or antenna(s) 352 of the UE 104 illustrated in FIG. 3 and/or the transceiver 1055 and the antenna 1060 of the communications device 1000 in FIG. 10.

### Example Clauses

Implementation examples are described in the following numbered clauses:

Clause 1: A method for wireless communications at a user equipment (UE), comprising: performing, while a session is active on a first radio access technology (RAT) network, reselection to a second RAT network from a third RAT network; performing a handover to the second RAT network, after detecting a condition impacting the session on the first RAT network; and resuming the session on the second RAT network.

Clause 2: The method of Clause 1, wherein the condition involves signal quality in the first RAT network.

Clause 3: The method of any one of Clauses 1-2, wherein performing the handover comprises transmitting a packet data network (PDN) handover request to the second RAT network.

Clause 4: The method of Clause 3, wherein the session is resumed on the second RAT network after receiving an acceptance of the PDN handover request.

Clause 5: The method of any one of Clauses 1-4, further comprising performing reselection to a third RAT network after an end of the session on the second RAT network.

Clause 6: The method of Clause 5, wherein the UE is camped on the third RAT network when it performs the reselection to the second RAT network.

Clause 7: The method of Clause 5, wherein the UE performs the reselection to the second RAT network irrespective of a relative priority assigned to the third RAT and second RAT.

Clause 8: The method of Clause 5, wherein: the session comprises a voice call; and the UE is capable of supporting evolved packet system (EPS) fallback for the voice call.

Clause 9: The method of Clause 5, wherein: the first RAT network comprises a wireless local area network (WLAN); and the second and third RAT networks comprise wireless wide area networks (WWANs).

Clause 10: The method of Clause 9, wherein: the second RAT network comprises a long term evolution (LTE) network; and the third RAT network comprises a new radio (NR) network.

Clause 11: An apparatus, comprising: at least one memory comprising executable instructions; and at least one processor configured to execute the executable instructions and cause the apparatus to perform a method in accordance with any one of Clauses 1-10.

Clause 12: An apparatus, comprising means for performing a method in accordance with any one of Clauses 1-10.

Clause 13: A non-transitory computer-readable medium comprising executable instructions that, when executed by at least one processor of an apparatus, cause the apparatus to perform a method in accordance with any one of Clauses 1-10.

Clause 14: A computer program product embodied on a computer-readable storage medium comprising code for performing a method in accordance with any one of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a user equipment (UE), comprising:
one or more processors configured to execute instructions stored on one or more memories and to cause the UE to:
perform, while a session is active on a first radio access technology (RAT) network, reselection to a second RAT network from a third RAT network;
perform a handover to the second RAT network, after detecting a condition impacting the session on the first RAT network; and
resume the session on the second RAT network.

2. The apparatus of claim 1, wherein the condition involves signal quality in the first RAT network.

3. The apparatus of claim 1, wherein in order to perform the handover, the one or more processors are further configured to cause the UE to transmit a packet data network (PDN) handover request to the second RAT network.

4. The apparatus of claim 3, wherein the session is resumed on the second RAT network after receiving an acceptance of the PDN handover request.

5. The apparatus of claim 1, wherein the one or more processors are further configured to cause the UE to perform reselection to a third RAT network after an end of the session on the second RAT network.

6. The apparatus of claim 5, wherein the one or more processors are configured to cause the UE to performs the reselection to the second RAT network when the UE is camped on the third RAT network.

7. The apparatus of claim 5, wherein the one or more processors are configured to cause the UE to perform the reselection to the second RAT network irrespective of a relative priority assigned to the third RAT and second RAT.

8. The apparatus of claim 5, wherein:
the session comprises a voice call; and
the UE is capable of supporting evolved packet system (EPS) fallback for the voice call.

9. The apparatus of claim 5, wherein:
the first RAT network comprises a wireless local area network (WLAN); and
the second and third RAT networks comprise wireless wide area networks (WWANs).

10. The apparatus of claim 9, wherein:
the second RAT network comprises a long term evolution (LTE) network; and
the third RAT network comprises a new radio (NR) network.

11. A method for wireless communications at a user equipment (UE), comprising:
performing, while a session is active on a first radio access technology (RAT) network, reselection to a second RAT network from a third RAT network;
performing a handover to the second RAT network, after detecting a condition impacting the session on the first RAT network; and
resuming the session on the second RAT network.

12. The method of claim 11, wherein the condition involves signal quality in the first RAT network.

13. The method of claim 11, wherein performing the handover comprises transmitting a packet data network (PDN) handover request to the second RAT network.

14. The method of claim 13, wherein the session is resumed on the second RAT network after receiving an acceptance of the PDN handover request.

15. The method of claim 11, further comprising performing reselection to a third RAT network after an end of the session on the second RAT network.

16. The method of claim 15, wherein the UE is camped on the third RAT network when it performs the reselection to the second RAT network.

17. The method of claim 15, wherein the UE performs the reselection to the second RAT network irrespective of a relative priority assigned to the third RAT and second RAT.

18. The method of claim 15, wherein:
the session comprises a voice call; and
the UE is capable of supporting evolved packet system (EPS) fallback for the voice call.

19. The method of claim 15, wherein:
the first RAT network comprises a wireless local area network (WLAN);
the second and third RAT networks comprise wireless wide area networks (WWANs);
the second RAT network comprises a long term evolution (LTE) network; and
the third RAT network comprises a new radio (NR) network.

20. A non-transitory computer-readable medium for wireless communications, comprising:
instructions that, when executed by one or more processors of a user equipment (UE), cause the UE to:
perform, while a session is active on a first radio access technology (RAT) network, reselection to a second RAT network from a third RAT network;
perform a handover to the second RAT network, after detecting a condition impacting the session on the first RAT network; and
resume the session on the second RAT network.
